(19) United States
(12) Patent Application Publication
(10) Pub. No.: US 2009/0272832 A1
(43) Pub. Date: Nov. 5, 2009

(54) Attachable Accessory Device

(76) Inventor: Gregory J. Gantzer, Cuyahoga Falls, OH (US)

Correspondence Address: JEANNE E. LONGMUIR, 2836 CORYDON ROAD, CLEVELAND HEIGHTS, OH, 44118, US

(21) Appl. No.: 12/345,147

(22) Filed: Dec. 29, 2008

Related U.S. Application Data
(60) Provisional application No. 61/016,861, filed on Dec. 27, 2007.

(51) Int. Cl. B65H 75/48; B65H 75/40; G09F 11/00

(52) U.S. Cl. 242/379.2

(57) ABSTRACT

An attachable accessory device is provided which has a housing assembly with an external cylindrical tube with an elongate slot, an internal cylindrical tube capable of rotational movement within the external cylindrical tube, and housing a spring member for providing the rotational movement. An elongate spring member is engaged within the internal cylindrical tube providing rotational movement of the internal cylindrical tube. A predetermined printed sheet of informational material with first and second protected surfaces to protect the informational material on the printed sheet, which has an elongate rigid handle secured to the printed sheet substantially along one edge, while an opposite edge of the printed sheet is secured with the internal cylindrical tube, so that the printed sheet is capable of being coiled or wound around the internal cylindrical tube under action of the elongate spring member and housed in a coiled condition within the external cylindrical tube, with the elongate handle extending from the external cylindrical tube through the elongate slot. An end cap secures the internal tube, elongate spring member and printed sheet within the external cylindrical tube. An attachment end is provided which extends from an opposite end of the external cylinder having the end cap, and has an opening therethrough for receiving an attachment device which may be attached to a user or to another alternate device.

### CROSS REFERENCE TO RELATED APPLICATIONS

This application claims priority from pending U.S. patent application Ser. No. 61/016,861 filed Dec. 27, 2007, the entire subject matter of which is incorporated herein by reference.

### FIELD OF INVENTION

The present application is directed to an improved accessory device, and more particularly to a holder having improved features, including having the accessory be attachable to clothing or other attachment accessories, such as a key chain or backpack.

### BACKGROUND OF THE INVENTION

A solution has been offered in the past to provide a container for a road map in an enclosure to contain and protect a regular sized road map. Such a container enables the road map to be maintained in a protected condition without requiring refolding, or getting wet or dirty during storage. Prior art devices which provide a number of features in such a container include U.S. Pat. No. 5,850,981.

### SUMMARY OF THE INVENTION

The present application provides an improved attachable accessory device. The attachable accessory device may be used for carrying a map, a schedule or other informational materials, within a housing which has an attachment device for connecting the map to clothing, luggage or other attachment accessories. The present accessory device is provided as a small sized device to enable, for example, the use of a small trail map by a skier or hiker, the use of a golf course map by a golfer or a transit authority schedule or map by a traveler. As indicated by these examples, which should not be interpreted as limiting the use of the present accessory device, the device is intended to be provided in a small size which may be readily attached to clothing worn by a person, or to baggage, a vehicle or other equipment, such as a ski jacket or golf bag, and such that the size of the accessory device is simple and fast to use, even with gloves, during participation in a sport or in cold weather, such as on a ski slope, the golf course or while traveling.

The unit has a plastic housing. The housing is a plastic tube with self-retracting or retractable printed material. The internal printed material is preferably made of paper and is water resistant and may be printed on one or both sides. The plastic tube with the retractable printed material is spring loaded, and automatically recoils the printed material within the housing for storage. The tube has a hole at one end where a metal attachment, such as a karabiner or a metal key ring is placed, to allow the device to be attached to a jacket, purse, etc, and to allow for easy two handed operation by a user. In an alternate embodiment, interchangeable maps may be provided for changing within the housing.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 illustrates the accessory device of the present application with the printed material pulled out from the housing for use.

FIG. 2 illustrates the accessory device of FIG. 1 attached to clothing, and with the printed material in retracted position fully within the housing.

FIG. 3 illustrates the accessory device parts in unassembled condition.

FIG. 4 illustrates a closer view of one end of the tube housing the printed material.

FIG. 5 illustrates a closer view of the spring assembly within the housing.

FIG. 6 schematically illustrates the components of the accessory device.

FIG. 7 illustrates an unattached accessory device of FIG. 1 with the printed material in retracted position fully within the housing.

FIG. 8 further illustrates an exploded view of the components of the attachable accessory device.

### DETAILED DESCRIPTION OF THE PREFERRED EMBODIMENT

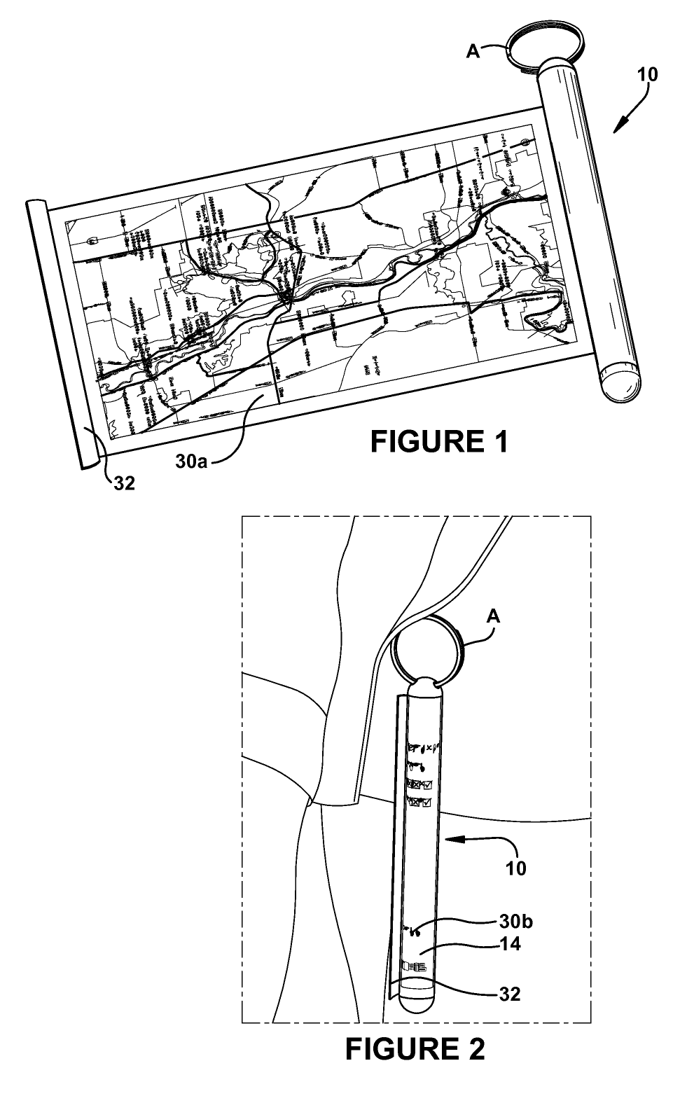

The present application provides an improved attachable accessory device for storage and use of printed material within a container or housing which is attached to a person or to another device. As shown in FIGS. 1-8, the attachable accessory device 10 may be used for storage of a printed sheet, and use of the printed sheet during attachment of the accessory device.

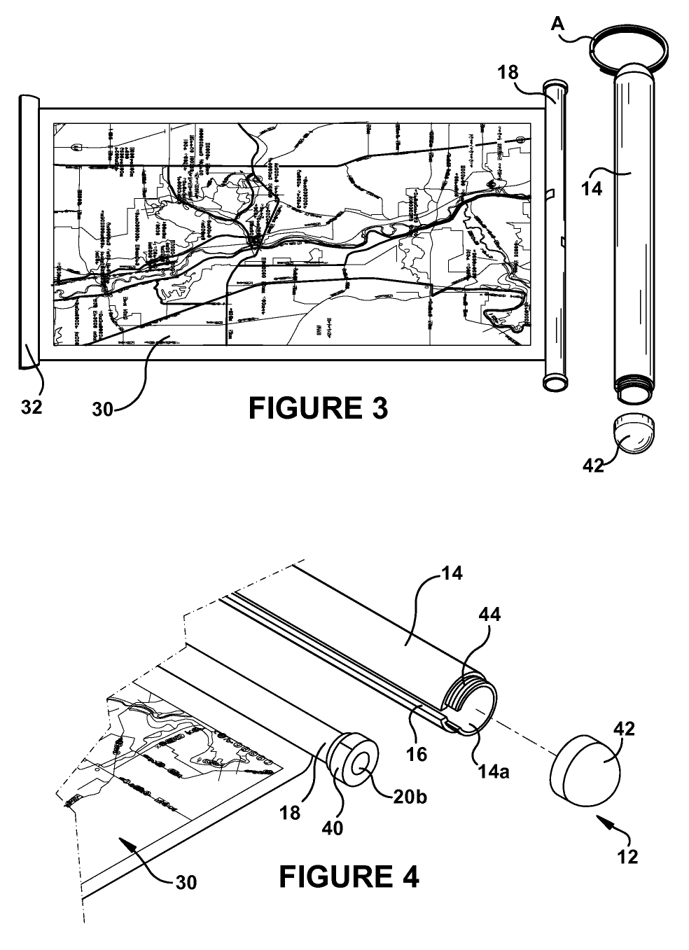

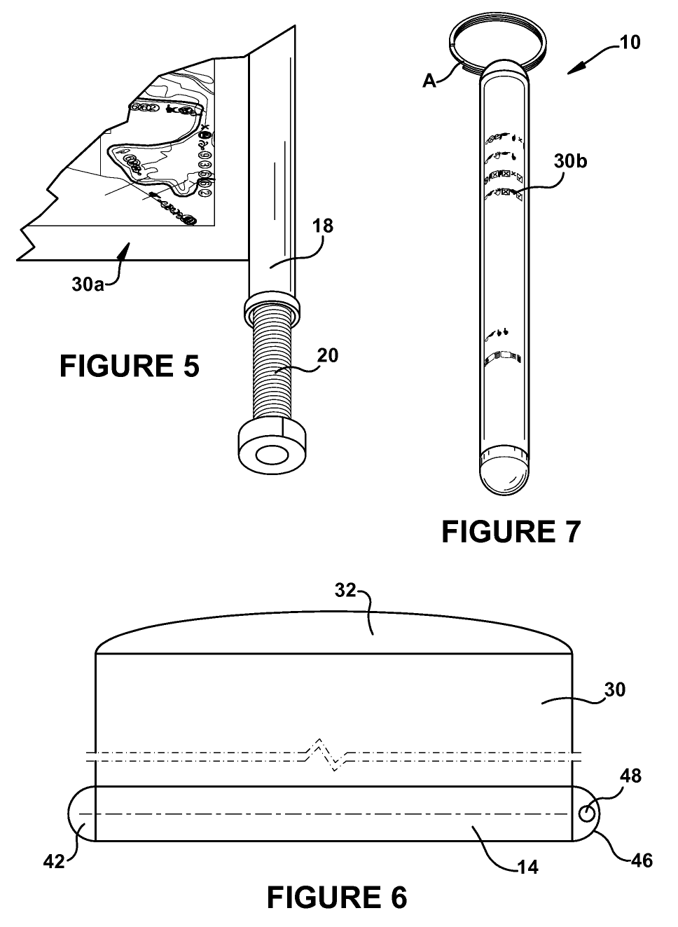

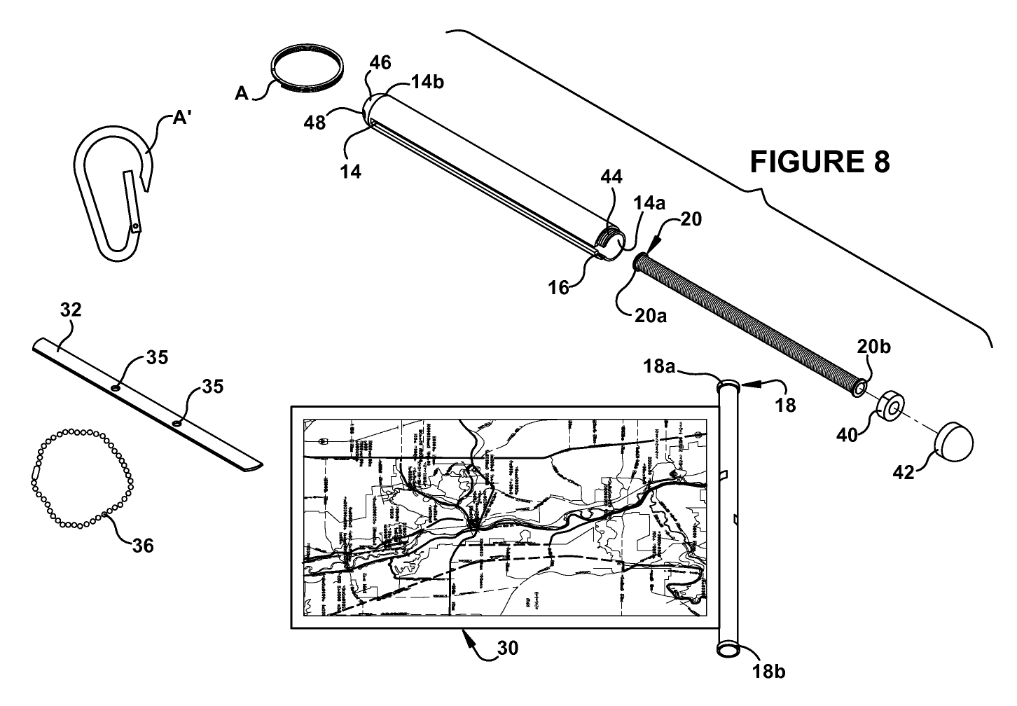

As shown in FIGS. 3-5 and 8, the attachable accessory device 10 includes a housing assembly 12. The housing assembly 12 has an external cylindrical tube 14 provided with an elongate slot 16, and an internal cylindrical tube 18. The internal cylindrical tube 18, has a smaller diameter than the external cylindrical tube 14, includes flanged ends 18a, 18b, is housed within the external cylindrical tube 14, and is capable of rotational movement within the external cylindrical tube 14. An elongate spring member 20, which is a metal torsion spring in the illustrated embodiment of FIGS. 5 and 8, is provided with flanged ends 20a, 20b, and is sized for imparting rotational movement, such that a printed sheet may be wound around the outside of the rotatable internal cylindrical tube 14. In the illustrated embodiments, the external cylindrical tube is a clear plastic material, and the internal cylindrical tube is an opaque plastic material. It will be understood that any appropriate prior art materials may be used

The printed sheet 30 is provided with predetermined informational material and has first and second printed surfaces 30a, 30b on the front and back. The printed sheet 30 is provided with water protected surfaces to protect the informational material on the printed sheet. Any predetermined desired information material may be printed on the first and second printed surfaces 30a, 30b of the printed sheet, including schedules, charts of information, maps or advertising. Where the external cylindrical tube 14 is provided of a clear material, the second printed surface 30b of the printed sheet 30 may be viewed when the printed sheet is wound within the housing assembly 12, as shown in FIG. 2, where the accessory device 10 is attached to a user's jacket.

The printed sheet 30 may be of any prior art plastic coated paper material, or laminated paper. For example, Nekoosa brand digital coated polyester paper, which is engineered specifically for high-heat laser printers and photocopiers, and has excellent tear-strength, durability, and waterproof qualities. An elongate rigid handle 32 is secured substantially along one edge 31 of the printed sheet. The handle 32 prevents the printed sheet 30 from retracting into the external cylindrical tube 14 and enables a user to grasp the printed sheet and extend it to a desired readable position, as shown in FIG. 1. In the illustrated embodiment of FIG. 8, the elongate handle 32 is provided as a clam shell configuration of aluminum material, which is folded and crimped, as shown in FIG. 3, to clamp or pinch the edge 31 of the printed sheet, and thereby secure the handle 32 to the printed sheet 30. An adhesive material may alternatively be used to secure the handle to the printed sheet. Openings 35 are provided within handle 32 for use of a pull chain or finger loop 36. As shown in FIG. 8, the finger loop may be a conventional removable metal or plastic chain, which is passed through the openings 35 in the handle to serve as further handle for the user.

Opposite the handle 32, an edge 33 of the printed sheet 30 is secured with the internal cylindrical tube by any appropriate adhesive, such as tape or other reattachment means, such that the printed sheet 30 is secured to the internal cylindrical tube 18, as shown in FIG. 8, and is capable of being coiled or wound around the internal cylindrical tube 18 under action of the elongate spring member 20 and housed in a coiled or wound condition within the external cylindrical tube 14, with the elongate handle 32 extending from the external cylindrical tube through the elongate slot 16. As shown, the spring member 20 includes flanged ends 20a, 20b, to seat the spring member within and spaced from an internal surface of the internal cylindrical tube 18. Additionally, flanged ends 18a, 18b are provided on the internal cylindrical tube 18, to support the internal cylindrical tube 18 within and spaced from an internal surface of the external cylindrical tube 18.

As shown in FIGS. 4 and 8, a spring end cap 40 is provided for securing the elongate spring member 20 with respect to the internal cylindrical tube 18, such that the flanged end 20b of the spring member is prevented from rotating with respect to the internal tube. Once assembled, by slidably inserting the internal cylindrical tube and spring with spring end cap into the external cylindrical tube with the printed sheet and handle extending from the slot 16, and threading the end cap 42 onto the threaded end 44 of the external cylindrical tube, the elongate spring member 20 is tensioned during retraction of the printed sheet from the external cylindrical tube 14, such that the internal cylindrical tube 18 rotates on its elongate axis with respect to both the fixed flanged end 20b of the spring member 20 and the external cylindrical tube 14. A housing end cap 42, having internal threads for mating threaded engagement with external threads 44 provided on an open end 14a of the external cylindrical tube 14, secures the elements of the housing assembly 12 in assembled condition. As shown in FIG. 6, the printed sheet preferably has a width sufficient to extend approximately the internal length of the external cylindrical tube 14.

An attachment end piece 46 is secured to and extends from an opposite end of the external cylindrical tube 14, and has an opening 48 therethrough for receiving an attachment device A. As shown, the attachment device A may be a conventional metal or plastic key ring. Alternatively, any universal connector may be used, such as a non-locking karabiner A′. The present application thus provides an attachable accessory device, which permits attachment to a user or a user's clothing, or to another device, such as luggage or a purse. More specifically, the present attachable accessory device 10 can be used by a user operating the device by pulling out the printed sheet 30 and reading the informational material printed on the printed sheet, 30a, 30b, while the device 10 is attached to something, either the user's clothing or another device, such as luggage, a purse, a ski pole, etc.

It should be understood that the threaded engagement of the end cap 42 enables the removal and reinsertion of an alternate printed sheet 30 and attached handle 32. The user is able to remove a first printed sheet 32 from adherence to the internal cylindrical tube 18, and retape or readhere a second desired predetermined printed sheet having information material to the internal cylindrical tube 18, and simply reinsert the internal cylindrical tube into the external cylindrical tube with the printed sheet and attached handle extending from the slot 16, and threading the end cap 42 into assembled condition. Making use of the interchangeable nature of the printed sheets 30 and handles 32 with the present device, enables the attachable accessory device to be sold as a kit with multiple predetermined printed sheets.

As a result, a city map tourist kit attachable accessory device may be provide with multiple sections of a city provided on different printed sheets 30, so that a tourist desiring to tour a specific section of a city on one day, may interchange the printed sheet 30 with a second printed sheet having a different section of the city to be toured on another day, for example. Similarly, charts of information, such as transportation schedules, may likewise be provided as a kit, so that the desired route may be used and interchanged with a second desired route. It is understood that the printed sheets 30 may be provided with a map or chart with the informational material on a first side 30a and advertising material on a second side 30b, or in any desired configuration.

All references, including prior art references, publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the device (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. An attachable accessory device comprising,
a) a housing assembly having an external cylindrical tube with an elongate slot and an internal cylindrical tube capable of rotational movement within the external cylindrical tube and for housing a spring member for providing the rotational movement;
b) an elongate spring member for engagement within the internal cylindrical tube providing rotational movement of the internal cylindrical tube;
c) a predetermined printed sheet of informational material having first and second protected surfaces to provide water protection for the informational material on the printed sheet, having an elongate rigid handle secured to the printed sheet substantially along one edge, an opposite edge of the printed sheet from the handle is secured with the internal cylindrical tube, such that the printed sheet is capable of being coiled or wound around the internal cylindrical tube under action of the elongate spring member and housed in a coiled condition within the external cylindrical tube, with the elongate handle extending from the external cylindrical tube through the elongate slot;
d) an end cap for securing the internal tube, elongate spring member and printed sheet within the external cylindrical tube; and
e) an attachment end extending from an opposite end of the external cylinder having the end cap and having an opening therethrough for receiving an attachment device so that the device may be used by a user while attached to another device.

2. The accessory device of claim 1 wherein the attachment device is a ring enabling attachment to another device.

3. The accessory device of claim 1 wherein the attachment device is a clip for enabling attachment to another device.

4. The accessory device of claim 1 wherein the attachment device is a karabiner enabling attachment to another device.

5. The accessory device of claim 1 wherein the printed sheet may be removed from the exterior housing and handle and replaced with another predetermined printed sheet having different informational material.

6. The accessory device of claim 1 wherein the printed sheet has printed matter provided on both sides of the sheet.

7. The accessory device of claim 1 wherein the external housing is clear plastic.

8. The accessory device of claim 1 wherein the informational material displayed on the printed sheet is a map or a schedule.

9. The accessory device of claim 1 wherein the elongate handle includes first and second openings through which are secured a finger loop to enable a user to expand and retract the printed sheet and attached elongate handle using the finger loop.

10. An attachable accessory device kit comprising,
an attachable accessory device having a housing assembly having an external cylindrical tube with an elongate slot and an internal cylindrical tube capable of rotational movement within the external cylindrical tube and for housing a spring member for providing the rotational movement;
an elongate spring member for engagement within the internal cylindrical tube providing rotational movement of the internal cylindrical tube;
at least two predetermined printed sheets of informational material, each printed sheet having first and second protected surfaces to provide water protection for the informational material on the printed sheet, an elongate rigid handle secured to the printed sheet substantially along one edge, and where an opposite edge of each printed sheet from the handle may be individually secured with the internal cylindrical tube, such that the desired individual predetermined printed sheet is capable of being coiled or wound around the internal cylindrical tube under action of the elongate spring member and housed in a coiled condition within the external cylindrical tube, with the elongate handle extending from the external cylindrical tube through the elongate slot;
an end cap for securing the internal tube, elongate spring member and printed sheet within the external cylindrical tube; and
an attachment end extending from an opposite end of the external cylinder having the end cap and having an opening therethrough for receiving an attachment device.
